(19) United States
(12) Patent Application Publication
(10) Pub. No.: US 2009/0128107 A1
(43) Pub. Date: May 21, 2009

(54) Low Dropout Voltage Regulator

(75) Inventors: Zhao WANG, Beijing (CN); Hang YIN, Beijing (CN); Wenbo TIAN, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/122,721

(22) Filed: May 19, 2008

(30) Foreign Application Priority Data
Nov. 21, 2007 (CN) 200710177830.1

(51) Int. Cl. G05F 1/00

(52) U.S. Cl. 323/280

(57) ABSTRACT

Improved designs of an LDO voltage regulator with ultra low quiescent current are disclosed. According to one embodiment, an LDO voltage regulator is designed to completely cancel an intermediate gain stage while decreasing a quiescent current and to stabilize a loop circuit by means of two zeros introduced in a frequency transfer function thereof. Such a LDO voltage regulator does not increase the power consumption and applicable in many circuits used in electronic devices.

### BACKGROUND OF THE INVENTION

1. Field of the Invention

The present invention relates to a voltage regulator, more particularly to a low dropout voltage regulator with an ultra low quiescent current.

2. Description of Related Art

DC/DC power (or voltage) converters are important in many electronic devices such as cellular phones and laptop computers, which are often supplied with power from batteries. Such electronic devices often contain several circuits with each circuit requiring a unique voltage level different from one supplied by the battery (sometimes being higher or lower than the battery voltage, and possibly even having negative voltage). Additionally, the battery voltage declines as its stored power is consumed. DC to DC converters offer a method of generating multiple controlled voltages from a single variable battery voltage, thereby saving space instead of using multiple batteries to supply different parts of the device. Examples of input voltage Vcc/output voltage Vout including 5V/3.3V, 5V/1.8V or 5V/1.2V etc. are widely used in various power management systems. Usually, an inductor and an output capacitor, which are very expensive and bulky, are necessary for a DC/DC down-converter.

Unlike many Switching Mode Power Supply (SMPS), a low dropout (LDO) voltage regulator needs only one ceramic capacitor for operation. As a voltage supply, the LDO voltage regulator demonstrates many advantages in applications. Perfect line and load regulation, high power supply rejection ratio (PSRR), fast response, very small quiescent current, and low noise make an LDO regulator irreplaceable.

In some electronic design applications, the LDO voltage regulators with a ultra low quiescent current are needed, e.g. to supply power for a real-time clock circuit. In many portable electronic products, the real-time clock circuit working all the time is employed for providing accurate time signal. In some electronic products, the real-time clock circuit still needs to accurately time even when changing battery. After the battery is unloaded, a capacitor preserving a little of energy is configured to supply power for the real-time clock circuit. Thus, it requires that the real-time clock circuit has a very low working current. Accordingly, the LDO voltage regulator used to supply power for the real-time clock circuit also needs to have a very low working current which generally is microampere in magnitude.

Additionally, the ceramic capacitor provided in the LDO voltage regulator is required to be reduced to 1 uF or less because the ceramic or tantalum capacitor having big capacitance is too bulky to be applied into the portable electronic products. Furthermore, the LDO voltage regulator needs to be able to work when the battery voltage is very low in order to increase the operating time of the portable electronic products.

In a conventional LDO voltage regulator, a PMOSFET is usually used as an out-pass transistor in order to avoid the problem of threshold loss introduced when an NMOSFET is used as the out-pass transistor. However, the gate of the PMOSFET has a relative larger capacitance. If the impedance of the gate of the PMOSFET is high enough, a low frequency pole will be formed to adversely affect the stability of the loop circuit.

In order to implement frequency compensation circuitry, a buffer is employed to decrease the impedance of the gate of the PMOSFET as shown FIG. 1. Thus, the pole is pushed to high frequency. However, this design scheme needs a common drain having large transconductance which has to introduce a large bias current. It is contradicted with the design requirement of low working current and goes against further optimizing the working current.

Another scheme of the frequency compensation is Miller compensation circuitry shown in FIG. 2 which is formed by a capacitor Cm and a resistor Rm. However, this design scheme also needs a large transconductance which has to introduce a large bias current. It is also contradicted with the design requirement of low working current and goes against to further optimize the working current.

In some conventional LDO voltage regulators, an out-capacitor has to be a tantalum capacitor having high equivalent series resistance or a ceramic capacitor having high capacitance to produce an external zero in a frequency transfer function thereof for stability because an internal compensation is not strong enough. However, this scheme increases considerably the manufacturing cost.

Thus, improved techniques for LDO voltage regulator with ultra low quiescent current are desired to overcome at least some or all of the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to improved techniques for LDO voltage regulator with ultra low quiescent current. According to one aspect of the present invention, an LDO voltage regulator contemplated in the present invention is able to completely cancel an intermediate gain stage while decreasing a quiescent current and to stabilize a loop circuit by means of two zeros in a frequency transfer function thereof. Such an LDO voltage regulator does not increase the power consumption and applicable in many circuits used in electronic devices.

Depending on implementation, the present invention may be implemented as a circuit, a method or a part of a system. In one embodiment, the present invention may be an LDO voltage regulator comprising:

an unregulated voltage input port;

a regulated voltage output port;

a differential amplifier having a pair of input terminals and an output terminal, one input terminal connected to a reference voltage;

a voltage divider connected between the regulated voltage output port and a ground reference and having a voltage divider node providing a feedback voltage to the other input terminal of the differential amplifier;

an output pass transistor having a control terminal connected to the output terminal of the differential amplifier, an input terminal connected to the unregulated voltage input port and an output terminal;

a compensation resistor connected between the regulated voltage output port and the output terminal of the output pass transistor; and

a compensation capacitor connected between the output terminal of the output pass transistor and the voltage divider node.

Many objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a circuit diagram showing one conventional LDO voltage regulator;

FIG. 2 is a circuit diagram showing another conventional LDO voltage regulator;

FIG. 3 is a circuit diagram showing a LDO voltage regulator according to a first embodiment of the present invention;

FIG. 4 is a circuit diagram showing a practical implement of the LDO voltage regulator in FIG. 3;

FIG. 5 is a curve diagram schematically showing a PSRR performance of the LDO voltage regulator in FIG. 3;

FIG. 6 is a circuit diagram showing the LDO voltage regulator according to a second embodiment of the present invention; and

FIG. 7 is a circuit diagram showing a practical implement of the LDO voltage regulator in FIG. 6.

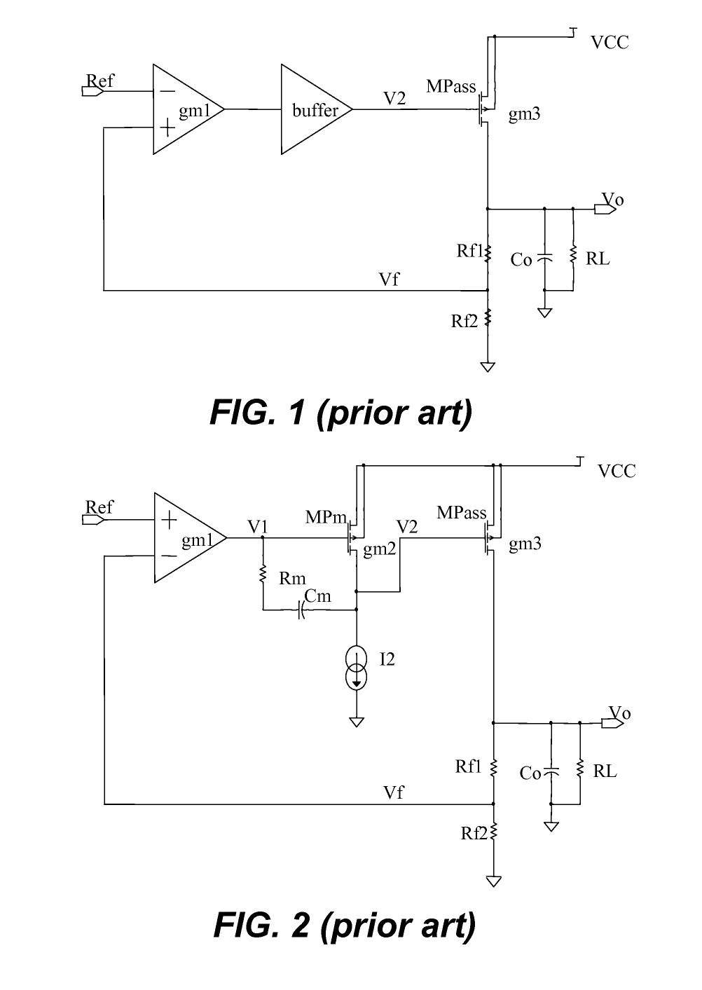

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

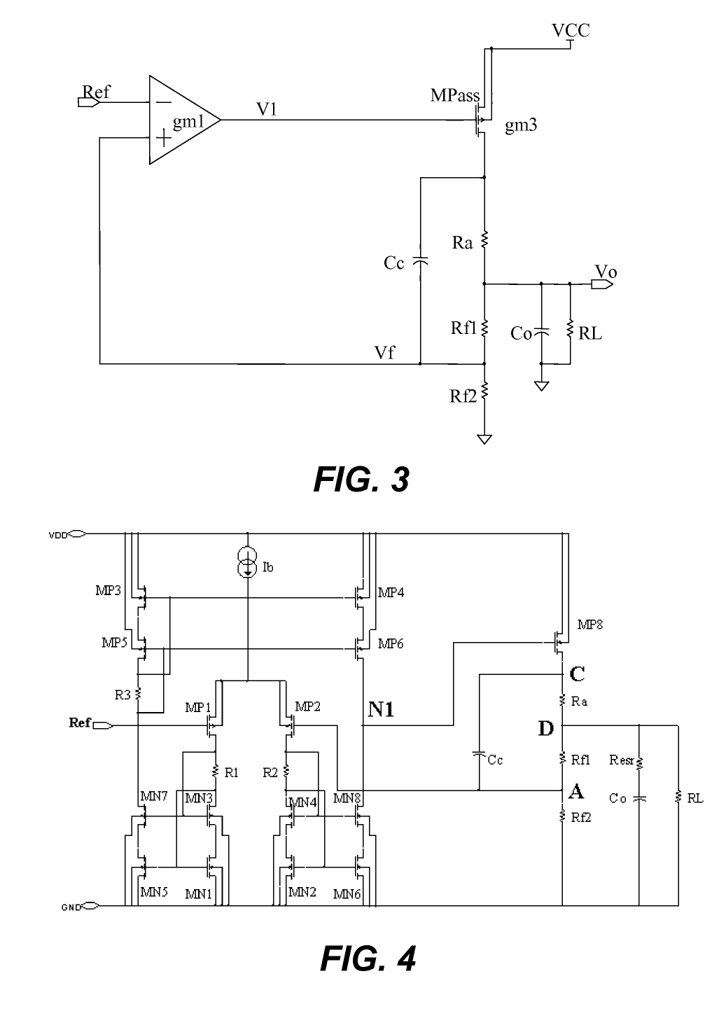

Embodiments of the present invention are discussed herein with reference to FIGS. 3-7. However, those skilled in the art will readily appreciate that the detailed description given herein with respect to these figures is for explanatory purposes only as the invention extends beyond these limited embodiments.

Generally, an LDO voltage regulator contemplated in the present invention is able to completely cancel an intermediate gain stage for decreasing a quiescent current and to stabilize a loop circuit by means of two-zero compensation which does not increase the current consumption. To facilitate the understanding of the present invention, two embodiments are provided to fully describe the low dropout (LDO) voltage regulator of the present invention.

### FIRST EMBODIMENT

FIG. 3 is a circuit diagram showing the LDO voltage regulator according to a first embodiment of the present invention. The LDO voltage regulator comprises an unregulated voltage input port, a regulated voltage output port, a reference voltage port, a differential amplifier, an output pass transistor and a voltage divider. An output capacitor Co and a load resistor RL are connected in parallel between the regulated voltage output port and a ground reference. The output capacitor Co has a parasitic equivalent series resistance Resr shown in FIG. 4.

The output pass transistor shown in FIG. 3 is a P-type MOS field effect transistor. A source terminal of the output pass transistor receives a power supply VCC at the unregulated voltage input port. The voltage divider includes a first ladder resistor Rf1 and a second ladder resistor Rf2 connected in series between the regulated voltage output port and the ground reference. A voltage divider node located between the ladder resistor Rf1 and the ladder resistor Rf2 provides a feedback voltage to a positive input terminal of the differential amplifier. The feedback voltage scales down a regulated output voltage Vo at the regulated voltage output port. A negative input terminal of the differential amplifier receives a reference voltage at the reference voltage port. An output terminal of the differential amplifier is connected to a gate terminal of the output pass transistor.

It should be noted that a resistor Ra is connected between a drain terminal of the output pass transistor and the regulated voltage output port, and a compensation capacitor Cc is connected between the drain terminal of the output pass transistor and the voltage divider node.

FIG. 4 is a circuit diagram showing a practical implement of the LDO voltage regulator in FIG. 3. The differential amplifier comprises a PMOS transistor differential pair MP1, MP2, a current source Ib and three current mirrors. A gate terminal of MP1 is used as a negative input terminal of the differential amplifier. A gate terminal of MP2 is used as a positive input terminal of the differential amplifier. Drain terminals of MP1 and MP2 are connected to input terminals of the first and second current mirrors, respectively. Source terminals of MP1 and MP2 are connected with each other and further connected to an output terminal of the current source Ib. An input terminal of the current source Ib is connected to the power supply VDD. An output terminal of the first current mirror is connected to an input terminal of the third current mirror. An output terminal of the second current mirror is connected to an output terminal of the third current mirror. Other terminals of the first and second current mirrors are connected to the ground reference. Other terminal of the third current mirror is connected to the power supply VDD. A node N1 where the output terminal of the second current mirror is connected with the output terminal of the third current mirror is used as the output terminal of the differential amplifier.

It can be seen that each current mirror in the differential amplifier has two branches, each adopting two stage cascade connection structure. Namely, MP5 is cascaded with MP3, MP4 is cascaded with MP6, MN1 is cascaded with MN3, MN2 is cascaded with MN4, MN5 is cascaded with MN7, and MN6 is cascaded with MN8. Thus, the differential amplifier may have a large swing amplitude and high gain.

Referring to FIG. 4, the first current mirror includes four NMOS transistors MN1, MN3, MN5, MN7 and a resistor R1. A gate terminal of MN1 is connected with a gate terminal of MN5 and further connected to one terminal of the resistor R1. A gate terminal of MN3 is connected with a gate terminal of MN7 and further connected to another terminal of the resistor R1. A drain terminal of MN3 is connected to the terminal of the resistor R1, where the gate terminals of MN1 and MN5 are connected. A source terminal of MN3 is connected with a drain terminal of MN1, and a source terminal of MN7 is connected with a drain terminal of MN5. Source terminals of MN1 and MN5 are grounded. The terminal of the resistor R1, where the gate terminals of MN3 and MN7 are connected, is used as the input terminal of the first current mirror. A drain terminal of MN7 is used as the output terminal of the first current mirror.

The second current mirror includes four NMOS transistors MN2, MN4, MN6, MN8 and a resistor R2. A gate terminal of MN2 is connected with a gate terminal of MN6 and further connected to one terminal of the resistor R2. A gate terminal of MN4 is connected with a gate terminal of MN8 and further connected to another terminal of the resistor R2. A drain terminal of MN4 is connected to the terminal of the resistor R2, where the gate terminals of MN2 and MN6 are connected to. A source terminal of MN4 is connected with a drain terminal of MN2, and a source terminal of MN8 is connected with a drain terminal of MN6. Source terminals of MN2 and MN6 are grounded. The terminal of the resistor R2, where the gate terminals of MN4 and MN8 are connected, is used as the input terminal of the second current mirror. A drain terminal of MN8 is used as the output terminal of the second current mirror.

The third current mirror includes four PMOS transistors MP3, MP4, MP5, MP6 and a resistor R3. A gate terminal of MP3 is connected with a gate terminal of MP4 and further connected to one terminal of the resistor R3. A gate terminal of MP5 is connected with a gate terminal of MP6 and further connected to another terminal of the resistor R3. A drain terminal of MP5 is connected to the terminal of the resistor R3 where the gate terminals of MP3 and MP4 are connected. A source terminal of MP5 is connected with a drain terminal of MP3, and a source terminal of MP6 is connected with a drain terminal of MP4. Source terminals of MP3 and MP4 are connected to the power supply VDD. The terminal of the resistor R3 where the gate terminals of MP5 and MP6 are connected is used as the input terminal of the third current mirror. A drain terminal of MP6 is used as the output terminal of the third current mirror.

In this embodiment, an output impedance of the differential amplifier is enhanced by adding MP6 and MN8. If no MP6 and MN8, the output impedance of the differential amplifier is r_{OP4}//r_{ON6}. After MP6 and MN8 is added, the output impedance of the differential amplifier becomes r_{OP4}.(g_{mP6}.r_{OP6})//r_{ON6}.(g_{mN8}.r_{ON8}). So, r_{OP4} is amplified by (g_{mP6}.r_{OP6}) times, and r_{ON6} is amplified by (g_{mP6}.r_{OP6}) times. Generally, the value of (g_{mP6}.r_{OP6}) and (g_{mP6}.r_{OP6}) is about 100. Thus, the cascade connection structure in the differential amplifier dramatically enhances the output impedance of the differential amplifier, which can push an internal dominant pole toward the lower frequency and separate two low frequency poles in the heavy load. r_{OP4} is an output resistance of the MP4 transistor in small signal, r_{OP6} is an output resistance of the MP6 transistor in small signal, g_{mP6} is a transconductance of the MP4 transistor in small signal, r_{ON6} is an output impedance of the MN6 transistor in small signal, g_{mN8} is a transconductance of the MN8 transistor in a small signal, and r_{ON8} is an output impedance of the MN8 transistor in small signal.

As described above, the intermediate gain stage is completely canceled from the LDO voltage regulator, which efficiently decreases the current consumption. In practice, the quiescent current of the LDO voltage regulator may be reduced to 0.4 uA.

The LDO voltage regulator according to the first embodiment of the present invention can work stably in an overall range of the load and the power supply when the output capacitor Co is very small, or even when the output capacitor Co is cancelled.

Analyzing a small signal equivalence of the LDO voltage regulator in FIG. 4, when the output capacitor Co is big enough, the loop circuit shown in FIG. 4 has three poles and two zeros listed as following.

$${f}_{p 1} = \frac{1}{2 π {R}_{1} {C}_{1}} , {f}_{p 2} = \frac{1}{2 π {R}_{L} {C}_{0}} , {f}_{P 3} = \frac{1}{2 π ( {R}_{f 1} // {R}_{f 2} ) {C}_{C}} , {f}_{Z 1} = \frac{1}{2 π {R}_{f 1} {C}_{C}} , {f}_{Z 2} = \frac{1}{2 π {R}_{a} {C}_{O}}$$

wherein R₁ represents an equivalent series resistance of the differential amplifier, C₁ represents an equivalent series capacitance of the differential amplifier. The first pole fₚ₁ is produced by the ESR R₁ and the ESC C₁ of the differential amplifier. The second pole fₚ₂ is produced by the load resistance R₁ and the output capacitor Co. The third pole fₚ₃ is produced by the resistors Rf1 and Rf2 and the compensation capacitor Cc. The first zero f_{Z1} is produced by the resistor Rf1 and the compensation capacitor Cc. The second zero f_{Z2} is produced by the resistor Ra and the output capacitor Cc.

It can be seen that the loop circuit is able to be stabilized as long as parameters of corresponding elements are properly choose to adjust frequency points of the zeros and the poles. For example, the values of R₁, C₁, R_{L}, Co, Rf1, Rf2, Cc, Ra can be properly choose to ensure that fₚ₁<( 1/10)*fₚ₂, f_{Z1}<3*fₚ₂, and f_{Z2}<3*fₚ₃, the second pole fₚ₂ is canceled by the first zero f_{Z1}, the third pole fₚ₃ is canceled by the second zero f_{Z2}. Thus, the first pole fₚ₁ is designed to be unique dominant pole of the loop circuit for stability.

When the output capacitor Co is cancelled or very small, the second pole fₚ₂ and the second zero f_{Z2} both locates at very high frequency and can be neglected. At this time, there are two poles fₚ₃, fₚ₁ and one zero f_{Z1} in the loop circuit. The first zero f_{Z1} can be used to cancel the third pole fₚ₃. Thus, the loop circuit still can be stabilized.

Additionally, a power supply rejection ratio (PSRR) of the LDO voltage regulator according to the first embodiment of the present invention can be enhanced. By analyzing the small signal equivalence of the LDO voltage regulator shown in FIG. 4, the PSRR is.

$$PSR = \frac{Vi}{Vo} \approx \frac{\begin{matrix}{g}_{mp 8} \cdot {g}_{mp 1} \cdot \frac{{R}_{f 2}}{{R}_{f 1} + {R}_{f 2}} \cdot \\ ( \frac{{g}_{mn 6}}{{g}_{mn 2}} ) + [ {g}_{on 6} \cdot ( \frac{{g}_{on 8}}{{g}_{mn 8}} ) + {g}_{op 4} \cdot ( \frac{{g}_{op 6}}{{g}_{mp 6}} ) ] / RL\end{matrix}}{{g}_{op 4} \cdot ( \frac{{g}_{op 6}}{{g}_{mp 6}} ) \cdot {g}_{mp 8}}$$

wherein Vi represents the unregulated input voltage of the LDO voltage regulator, Vo represents the regulated output voltage of the LDO voltage regulator, gₘₚ₈ is a transconductance of MP8, gₘₚ₁ is a transconductance of MP1, gₘₚ₆ is a transconductance of MP6, gₘₙ₂ is a transconductance of MN2, gₒₙ₆ is an output admittance of MN6, gₒₚ₄ is an output admittance of MN8, gₘₙ₈ is a transconductance of MN8, gₒₚ₄ is an output admittance of MP4, gₒₚ₆ is an output admittance of MP6, gₘₚ₆ is a tansconductance of MP6.

Simplifying the above equation, the following equation can be obtained:

$$PSR = \frac{Vi}{Vo} \approx \frac{{g}_{mp 8} \cdot {g}_{mp 1} \cdot \frac{{R}_{f 2}}{{R}_{f 1} + {R}_{f 2}} \cdot ( \frac{{g}_{mn 6}}{{g}_{mn 2}} )}{{g}_{op 4} \cdot ( \frac{{g}_{op 6}}{{g}_{mp 6}} ) \cdot {g}_{mp 8}} = ( \frac{{g}_{mp 1}}{{g}_{op 4}} ) \cdot ( \frac{{g}_{mp 6}}{{g}_{op 6}} ) \frac{{R}_{f 2}}{{R}_{f 1} + {R}_{f 2}} \cdot ( \frac{{g}_{mn 6}}{{g}_{mn 2}} )$$

wherein

$$\frac{{R}_{f 2}}{{R}_{f 1} + {R}_{f 2}} \cdot ( \frac{{g}_{mn 6}}{{g}_{mn 2}} )$$

is generally close to 1,

$$( \frac{{g}_{mp 1}}{{g}_{op 4}} )$$

is generally about 100, and

$$( \frac{{g}_{mp 6}}{{g}_{op 6}} )$$

is generally about 100. The products of

$$( \frac{{g}_{mp 1}}{{g}_{op 4}} )$$

and

$$( \frac{{g}_{mp 6}}{{g}_{op 6}} )$$

is about 10000, which, when transformed into dB quantity, is about 80 dB. In any case, the PSR must be larger than 60 dB, which indicates that the variation of the output voltage can be reduced to 1 mV if the variation of the input voltage 1V. 80 dB indicates that the variation of the output voltage can be reduced to 0.1 mV if the variation of the input voltage is set to be 1V.

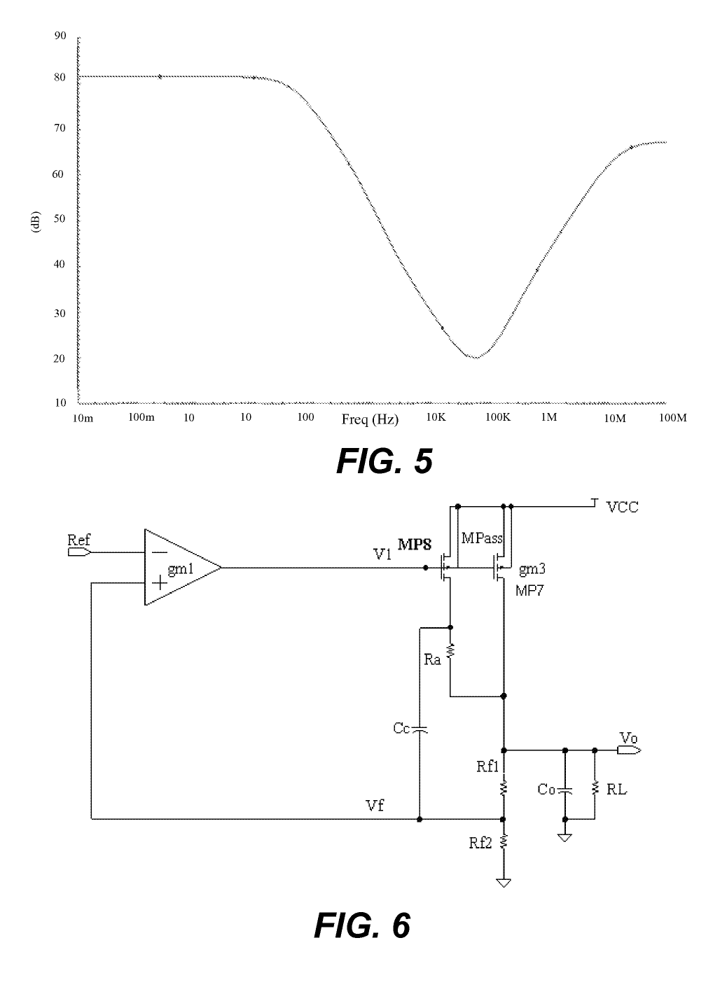

FIG. 5 is a curve diagram schematically showing a PSRR performance of the LDO voltage regulator in FIG. 3. As shown in FIG. 5, the PSRR of the LDO voltage regulator can reach 80 dB at low frequency. Furthermore, the minimum value of the PSRR of the LDO voltage regulator is larger than 20 dB which can still satisfy applied requirement in most cases.

### SECOND EMBODIMENT

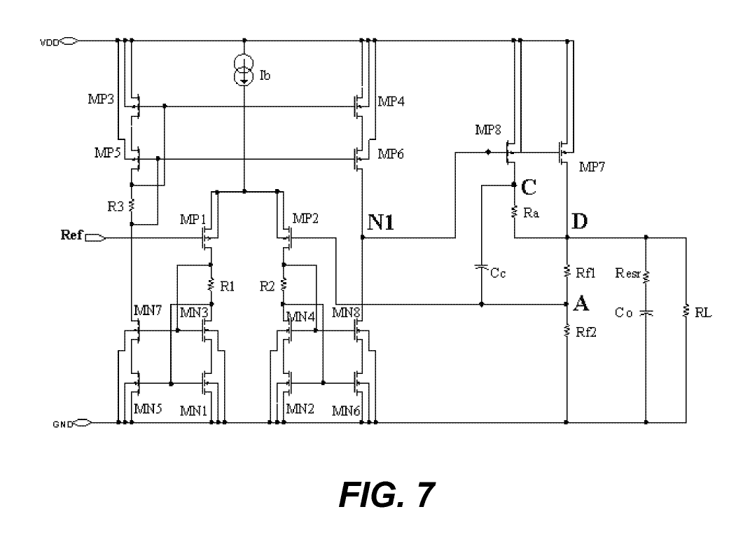

In the embodiment of FIG. 3, since the resistor Rₐ requires to satisfy a predetermined condition and avoid an obvious voltage dropout thereon, the resistor Rₐ must be designed to be very small. The value of the resistor Rₐ is preferably designed to be less than 1Ω. It is difficult to fabricate such a resistor with so small resistance. Hence, FIGS. 6 and 7 show another LDO voltage regulator according to a second embodiment of the present invention.

The LDO voltage regulator shown in FIG. 6 is same with that shown in FIG. 3 except that the former further comprises another output pass transistor MP7. A gate terminal of the output pass transistor MP7 is connected with the gate terminal of the output pass transistor MP8. A source terminal of MP7 is connected to the unregulated voltage input port. A drain terminal of MP7 is connected to the regulated voltage output port.

In this embodiment, the ratio (W/L)_{MP8} of width to length of the output pass transistor MP8 is far less than the ratio (W/L)_{MP7} of width to length of the output pass transistor MP7, wherein the ratio of (W/L)_{MP8} to (W/L)_{MP7} is 1/10000˜1/10, so the current flowing through the output pass transistor MP8 and the resistor Ra will be far less than that flowing through the output pass transistor MP7.

Provided that N=(W/L)_{MP7}/(W/L)_{MP8}, analyzing the second zero f_{Z2} produced by the resistor Ra and the output capacitor Co again, the following can be obtained:

$${f}_{Z 2} = \frac{1}{2 π {R}_{a} {C}_{O} / N}$$

The value of Rₐ/N in this embodiment may be near to the value of the Rₐ in the first embodiment. Namely, when the same second zero is formed, the value of Ra in the second embodiment is N times of the value of Ra in the first embodiment. Thus, the resistor Ra with big resistance can be fabricated easily.

Additionally, the output pass transistor of the present invention may be an N-type MOS transistor in some embodiments. Furthermore, the output pass transistor MP7 or MP8 may consist of a plurality of PMOS transistor connected in parallel.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. An LDO voltage regulator, comprising:
an unregulated voltage input port;
a regulated voltage output port;
a differential amplifier having a pair of input terminals and an output terminal, one input terminal connected to a reference voltage;
a voltage divider connected between the regulated voltage output port and a ground reference and having a voltage divider node providing a feedback voltage to the other input terminal of the differential amplifier;
an output pass transistor having a control terminal connected to the output terminal of the differential amplifier, an input terminal connected to the unregulated voltage input port and an output terminal;
a compensation resistor connected between the regulated voltage output port and the output terminal of the output pass transistor; and
a compensation capacitor connected between the output terminal of the output pass transistor and the voltage divider node.

2. The LDO voltage regulator according to claim 1, wherein the out pass transistor is a P-type MOS field effect transistor, a gate electrode of the PMOS field effect transistor serves as the control terminal, a source electrode of the PMOS field effect transistor serves as the input terminal and a drain electrode of the PMOS field effect transistor serves as the output terminal.

3. The LDO voltage regulator according to claim 1, further comprising an output capacitor connected between the regulated voltage output port and the ground reference.

4. The LDO voltage regulator according to claim 1, further comprising a load resistor connected between the regulated voltage output port and the ground reference.

5. The LDO voltage regulator according to claim 1, wherein the voltage divider comprises a first ladder resistor and a second ladder resistor connected in series, the voltage divider node is located between the first ladder resistor and the second ladder resistor.

6. The LDO voltage regulator according to claim 2, further comprising another output pass transistor being a P-type MOS field effect transistor, wherein a drain electrode of the another output pass transistor is connected to the regulated voltage output port, a source electrode of the another output pass transistor is connected to the unregulated voltage input port, and a gate electrode of the another output pass transistor is connected to the output terminal of the differential amplifier.

7. The LDO voltage regulator according to claim 6, wherein a current flowing through the output pass transistor is less than a current flowing through the another output pass transistor.

8. The LDO voltage regulator according to claim 1, wherein the differential amplifier comprises a plurality of current mirrors, each branch of the current mirrors adopts two stage cascade connection of NMOS transistors or PMOS transistors.

9. An LDO voltage regulator, comprising:
an unregulated voltage input port;
a regulated voltage output port;
a differential amplifier having a pair of input terminals and an output terminal, one input terminal connected to a reference voltage;
a voltage divider connected between the regulated voltage output port and a ground reference and having a voltage divider node providing a feedback voltage to the other input terminal of the differential amplifier;
a first output pass transistor having a control terminal connected to the output terminal of the differential amplifier, an input terminal connected to the unregulated voltage input port and an output terminal;
a second output pass transistor having a control terminal connected to the output terminal of the differential amplifier, an input terminal connected to the unregulated voltage input port and an output terminal connected to the regulated voltage output port;
a compensation resistor connected between the regulated voltage output port and the output terminal of the first output pass transistor;
a compensation capacitor connected between the output terminal of the first output pass transistor and the voltage divider node.

10. The LDO voltage regulator according to claim 9, wherein the pass transistors both are P-type MOS field effect transistors, a gate electrode of the MOS field effect transistor serves as the control terminal, a source electrode of the MOS field effect transistor serves as the input terminal, and a drain electrode of the MOS field effect transistor serves as the output terminal.

11. The LDO voltage regulator according to claim 9, wherein a current flowing through the first output pass transistor is less than a current flowing through the second output pass transistor.

12. The LDO voltage regulator according to claim 9, further comprising an output capacitor and a load resistor connected in parallel between the regulated voltage output port and the ground reference.

13. The LDO voltage regulator according to claim 9, wherein the ratio of width to length of the first pass transistor is O, the ratio of width to length of the second pass transistor is P, the ratio of O to P is within 1/10000˜1/10.

14. The LDO voltage regulator according to claim 12, wherein the LDO voltage regulator has three poles and two zeros within bandwidth, two of the three poles are cancelled by corresponding zeros and another pole is designed to be a domain pole, and wherein one of the two zeros is formed by the output capacitor and the compensation resistor.

15. The LDO voltage regulator according to claim 9, wherein the differential amplifier comprises a plurality of current mirrors, each branch of the current mirrors adopts two stage cascade connection of NMOS transistors or PMOS transistors.

16. An LDO voltage regulator, comprising:
first and second output pass transistors having a common gate electrode receiving a control signal, a common source electrode connected to an unregulated voltage input port, an output current of the fist output pass transistor less than an output current of the second output pass transistor, a drain electrode of the second output pass transistor connected to a regulated voltage output port;
a compensation resistor connected between the regulated voltage output port and a drain electrode of the first output pass transistor;
a compensation capacitor connected between the drain terminal of the first output pass transistor and a voltage feedback node.
